(19) United States
(12) Patent Application Publication
(10) Pub. No.: US 2009/0289011 A1
(43) Pub. Date: Nov. 26, 2009

(54) MOBILE WATER PURIFICATION SYSTEM AND METHOD

(75) Inventor: Karen F. Avakian, New York, NY (US)

Correspondence Address: KRAMER LEVIN NAFTALIS & FRANKEL LLP;INTELLECTUAL PROPERTY DEPARTMENT, 1177 AVENUE OF THE AMERICAS, NEW YORK, NY, 10036, US

(73) Assignee: WATER SAFE SOLUTIONS, INC.

(21) Appl. No.: 12/470,884

(22) Filed: May 22, 2009

Related U.S. Application Data
(60) Provisional application No. 61/055,351, filed on May 22, 2008.

(51) Int. Cl. C02F 9/04; C02F 1/32

(52) U.S. Cl. 210/668; 210/259; 210/258; 210/182; 210/202

(57) ABSTRACT

An improved water purification system and method for converting contaminated water into potable water in an inexpensive and reliable manner that includes several active and passive purification components contained within a housing. The passive components may include, for example, a macro filtration unit for filtering debris; a pre-depth mixed bed media filtration unit to mechanically filter out various contaminants; and a post-depth mixed bed media filtration unit to remove particles or organic growth that may have resulted from active filtration. The active components may include, for example, a specialized media filtration unit to destroy and remove organic and inorganic contaminants; an ozonation unit to break down and destroy oxidizable matter; an active carbon filtration unit to neutralize ozone, adsorb contaminants, and improve taste; and a UV sterilization unit to destroy any remaining microorganisms and neutralize ozone.

### TECHNICAL FIELD

The present invention relates generally to water purification systems, and more particularly to an improved water purification system and method for purifying contaminated water so as to be potable in quantities sufficient to meet the needs of entire communities.

### BACKGROUND INFORMATION

In developing countries, contaminated drinking water is extremely problematic, leading to widespread infection and disease. Moreover, in nations where water is scarce, purified drinking water is often too expensive for the average citizen to buy. In addition, the quantities of purified drinking water available are limited.

Such problems may also exist temporarily in areas that have been hit by natural disasters such as, for example, hurricanes, earthquakes and floods. In disaster situations, water mains may be ruptured or compromised and often cannot be relied on. Conventional methods of providing large quantities potable drinking water in disaster areas are limited in efficacy and feasibility. For example, water is often brought to a disaster area in large containers. This method is extremely expensive, very cumbersome, and nearly always unable to meet demand. Alternatively, treating contaminated water by boiling does not eliminate endotoxins, chemicals, or radioactive contamination that are often present in disaster situations.

Many conventional methods also have serious unwanted side effects. Some conventional water purification methods involve purification via filtration and the subsequent use of chemical disinfectants, such as chlorine. However, chemical disinfectants can have harmful side effects, and some in particular, such as chlorine, can lead to the formation of carcinogens or cause birth defects.

Another disadvantage of attempts to provide easily transportable water purification systems is a lack of sufficient redundancy to assure a high quality end product if an individual component breaks down. Such a lack of redundancy may also increase the load on individual components, thus leading to reduced reliability. Moreover, although conventional water purification systems often use ozonation, they generally lack sufficient means to eliminate ozone, which may cause nausea, if left in water in sufficient quantities.

What is needed is an improved water purification system and method that overcomes the above-noted disadvantages associated with previous water purification systems and methods, that does not add any potentially harmful chemicals to the water, that may be easily transported, and that utilizes redundancy to ensure conversion of contaminated water to potable water even if an individual component breaks down or becomes overloaded with contaminants. The system may be operated while backwashing the overloaded component.

### SUMMARY OF THE INVENTION

An improved water purification system and method is presented for the conversion of contaminated water into potable water in an inexpensive and reliable manner. In exemplary embodiments of the present invention, a water purification system, and associated method, can include several layers of active and passive purification components contained within a housing. The passive components can include, for example, a macro filtration unit for filtering debris; a pre-depth mixed bed media filtration unit to mechanically filter out various contaminants from the water; and a post-depth mixed bed media filtration unit to remove particles or organic growth that may result from active filtration. The active components can include, for example, a specialized media filtration unit to destroy and remove organic and inorganic contaminants; an ozonation unit to break down and destroy oxidizable matter; an active carbon filtration unit to neutralize ozone, adsorb contaminants, and improve taste; and a ultraviolet (UV) sterilization unit to destroy remaining microorganisms and neutralize ozone. In an exemplary embodiment of the present invention, contaminated water may be fed into the system from a holding tank constructed of, for example, 304 gauge steel. In other exemplary embodiments of the present invention, contaminated water may be fed directly into the system from a variety of sources, such as a well, river, or water main, via at least one feed pump.

The system is configurable and may be installed as a permanent filtration system, hard-piped from a suitable water source to a hospital, residential community, school, large apartment or office building.

For mobile, emergency or field applications, certain tanks within the system would be constructed of polypropylene, fiberglass or similar lightweight materials, and redundant tanks may be eliminated to insure ease of transportation.

### BRIEF DESCRIPTION OF THE DRAWINGS

It is to be understood that the following drawings are designed as an illustration only and not as a definition of the limits of the invention. In the drawings similar reference characters denote similar elements throughout the several views:

FIG. 1 is a block diagram of a configuration of components of the water purification system according to an exemplary embodiment of the present invention; and

FIG. 2 depicts a diagram of an exemplary backwashing of the water purification system according to an exemplary embodiment of the present invention;

### DETAILED DESCRIPTION

In exemplary embodiments of the present invention, a water purification system and method may include several active and passive purification components contained within a housing. The passive components may include, for example, a macro filtration unit for filtering debris; a pre-depth mixed bed media filtration unit to mechanically filter out various contaminants; and a post-depth mixed bed media filtration unit to remove particles or organic growth that may have resulted from active filtration. The active components may include, for example, a specialized media filtration unit to destroy and remove organic and inorganic contaminants; an ozonation unit to break down and destroy oxidizable matter; an active carbon filtration unit to neutralize ozone, adsorb contaminants, and improve taste; and a UV sterilization unit to destroy any remaining microorganisms and neutralize ozone.

The exemplary water purification system may also include an independent power supply that may supply power from a power grid, if available, or in the event of a power failure (or where no power is available), from an on-board generator. The generator may be fueled by diesel or gasoline. The generator may also be a hybrid generator powered by solar, wind or biomass fuel, depending on the location and available sources at the point of use.

Before being fed into the system, contaminated water may first pass through a macro filtration unit which may comprise, for example, a mesh screen filter to remove sediment and particulate matter larger than one-sixteenth to one-eighth of an inch. Such a unit may be visible from the outside of the system housing so that the filter may be observed and easily removed for maintenance. Although not necessary, the macro filtration unit may be useful to protect pumps, valves and other components from damage, to prevent clogging of downstream filters and entry of objects which could hamper a downstream backwash cycle, and to decrease the frequency of backwashing.

Contaminated water may be fed into the system from a holding tank via at least one feed pump. Such a holding tank for source water allows for a steady supply of feed water to the system as well as to offer a control to test for various types of contamination. Alternatively, contaminated water may be fed into the system directly from a source, such as a well, river, or water main, via at least one feed pump. In an exemplary embodiment of the present invention, two feed pumps may be provided so that if one breaks down, the system may function even if the pump that fails cannot be immediately repaired or replaced.

The contaminated water may pass through a pre-depth media passive filtration stage. At this stage, at least one mixed bed media filter may be utilized to mechanically trap suspended contaminants such as suspended metals, Teflon, fecal coliforms, oils, greases, and algae. The mixed bed media filter preferably may comprise, for example, a cartridge containing anthracite, silica sand, garnet, quartz and/or copper-zinc material. In such an exemplary filter, the quartz may act as distribution media, the carbon removes organics, taste, odors and soluble particulates from the water, and the copper-zinc material may be used for its galvanic action to remove chlorine, heavy metals, bacteria, algae and fungi. In an alternative exemplary embodiment of the present invention, multiple mixed bed media filters may be provided in parallel to create redundancy in event one of the filters fails or overloads.

Following the pre-depth media passive filtration stage, the water may then pass through a first active filtration stage. At this stage, at least one specialized media filter unit may be utilized to actively destroy a wide variety of organisms and form a covalent bond with the contaminants it destroys. By actively destroying and removing such contaminants, it can substantially reduce the burden on, and extends the life of, the system components that follow. In specific applications, the specialized media filter unit may be an anti-microbial media filter, which may be both bacteriostatic and viralcidal.

According to exemplary embodiments of the present invention, a second active filtration stage, that of ozonation, may follow the first active filtration stage. In this stage, the feed water may enter an ozonation contact tank to be vigorously mixed with ozone gas. The ozone interacts with any oxidizable matter, including remaining bacteria, other microorganisms, endotoxins, and metals. While ozonation leaves residual ozone in the water, which may cause nausea, the ozone generally converts back to oxygen after a few hours. However, because water may be need for consumption immediately following purification, subsequent stages may be provided immediately after the ozonation stage to convert residual ozone to oxygen more quickly.

Following the second active filtration stage, in exemplary embodiments of the present invention, the water then enters a post-depth media passive filtration stage mixed bed media filtration unit. This stage utilizes a mixed bed media filter to remove back destroyed microorganisms and any particles which have grown in size as a result of oxidation, such as dissolved iron or manganese.

The feed water then passes through an activated carbon filtration stage. The activated carbon may serve at least three purposes. First, the carbon may neutralize ozone by converting it into oxygen. Second, it may adsorb inorganic and organic compounds, including restructured molecules coming from the ozone contact tank. Third, the carbon may improve the taste of the water by removing contaminants and remains of altered molecules, including endotoxins. In exemplary embodiments of the present invention, the activated carbon filtration stage may include two components. The first component may be a granular activated carbon (GAC) filter, while the second component may be a half to one micron rated carbon block filter.

A final stage of the purification process may be active UV sterilization. UV germicidal sterilization may destroy the genetic DNA of bacteria and microorganisms, effectively disabling their reproduction. Thus, the UV sterilization may provide redundancy in destroying any microorganisms that may remain in the purified water and in converting residual ozone to oxygen. In exemplary embodiments of the present invention, the UV sterilization unit may be located between the first and second components of the active carbon filtration stage. In an alternative arrangement, the UV sterilization may be located before the carbon filtration stage.

In exemplary embodiments of the present invention, other filtration units may be provided within the system, such as, for example, filters for arsenic removal and water color treatment.

Because the arrangement of the components of the system can provide built-in redundancy, exemplary embodiments of the present invention continue to deliver safe drinking water even if one or more components require backwashing or replacement. If any of the components reaches its capacity, the component may be bypassed while it is replaced or backwashed without altering the quality of the product water or halting the operation of the system because the remaining active and passive components may provide sufficient purification. Thus, the risk of downtime due to component failure may be dramatically reduced according to various aspects of the present invention.

For example, if the specialized media filter ceases to properly function, the ozonation unit, activated carbon filtration, and UV sterilization may remove and/or destroy microorganisms present in the water. In another example, if the ozonation unit ceases to properly function (for example, if an ozone generator breaks down), the specialized media filtration, activated carbon filtration, and UV sterilization can remove and/or destroy microorganisms present in the water. In yet another example, if the activated carbon filtration unit ceases to properly function, the specialized media filtration, the ozonation and UV sterilization may remove and/or destroy microorganisms present in the water, the mixed-bed media filtration may remove other contaminants, and the UV sterilization may neutralize residual ozone resulting from the ozonation unit. In a final example, if the UV sterilization breaks down, the specialized media filtration and activated carbon filtration may remove and/or destroy microorganisms present in the water, and the activated carbon filtration can neutralize residual ozone resulting from the ozonation.

As the various filters collect particulate matter, their ability to filter contaminants may be reduced and the pressure drop across them may increase, thereby decreasing the filtration capacity of the entire system. As a result, various filters may require periodic backwashing and/or replacement. According to exemplary embodiments of the present invention, the macro filtration unit, mixed-bed media filtration units, the specialized filtration unit, and activated carbon filtration units can be modular and use filter cartridges that may be quickly and easily replaced, thereby reducing downtime. In addition, the redundancy provided by the system reduces the burden on the individual components of the system, thus increasing reliability and lifespan of each individual component.

Following all the purification stages, the purified water may be held in a filtered water holding tank to store excess purified water when the capacity exceeds demand and to ensure a steady supply of filtered water when demand exceeds capacity. Water may dispensed from the holding tank via at least one dispensing station. In addition, the system can include at least one vessel cleaning station which utilizes purified water to clean a variety of vessels (for example, a water bottle or jug) so that they do not contaminate the newly purified water. Multiple dispensing stations and cleaning stations allow for increased speed and efficiency of distribution.

The present invention is designed to maximize the efficiency and filtration capacity of the system while minimizing the size of the entire system in order to improve portability. In exemplary embodiments of the present invention, each individual component has been designed to efficiently and effectively perform its function in a reliable and cost effective manner. Thus, it is not the case that if an individual component is loaded beyond its capacity the system comes to a halt, but rather that components can be bypassed and operation continued.

The system may include an additional holding tank with an inlet, for example, between the ozonation unit and the post-depth media filtration unit to collect ozonated water for later use during an optional backwash cycle. Ozonated water can be fed from the holding tank by a backwash pump in reverse through the macro filtration, mixed bed media filtration, anti-microbial media filtration, activated carbon filtration, and any other filtration stages that may benefit from backwashing.

Backwashing is known as a form of maintenance to increase the lifespan of the filtration media, thus increasing efficiency and reducing cost. Ordinarily, backwashing is performed by separate equipment and is not integrated the actual filtration system. By such integration, backwashing may be performed quickly, easily and simultaneously on all the filtration components that may benefit from it, thus reducing downtime and increasing efficiency.

Redundant filters allow for heavily loaded filters to be bypassed and filtration to continue while the loaded filters are backwashed, making them ready for return to the process when the next filter is ready to be backwashed.

In another exemplary embodiment of the present invention, the system may include a Geiger counter to detect radioactive contamination of the water and a de-radiation loop to remove radioactive particles. The radiation loop utilizes specialized media that removes, for example, particles of radioactive uranium before the water is allowed to enter the filtration units. Water may monitored by a Geiger counter before it is returned to the system.

In yet another exemplary embodiment of the present invention, the system also can include decontamination showers which can utilize water from the filtered water tank. Water used in this manner can be recollected and held for re-purification by the system, thus conserving and recycling the viable water supply. This exemplary embodiment may include a tankless water heater to provide hot water to the showers.

To allow the system to operate in cold weather, the system may include an internal heating system.

The system according to the present invention may take contaminated water, including grey water, and purify it into drinking water in a simple and economic manner. The system according to exemplary embodiments of the present invention may supply safe drinking water to an entire community, such as a village, at low cost and with low maintenance. The system can be transported via a trailer or helicopter to the desired location. The system may be equipped to supply 5,000 to 15,000 gallons of potable water per day, sufficient to supply the daily drinking water needs of about 1,000 to 3,000 people, according to World Health Organization standards. The system may be used in parallel to service larger populations.

Because the system, according to the current invention, is an active purification system, it produces the maximum efficiency of water of human consumption, unlike reverse osmosis systems that filter out contaminants and produce a waste stream of 50% to 70% of the input water.

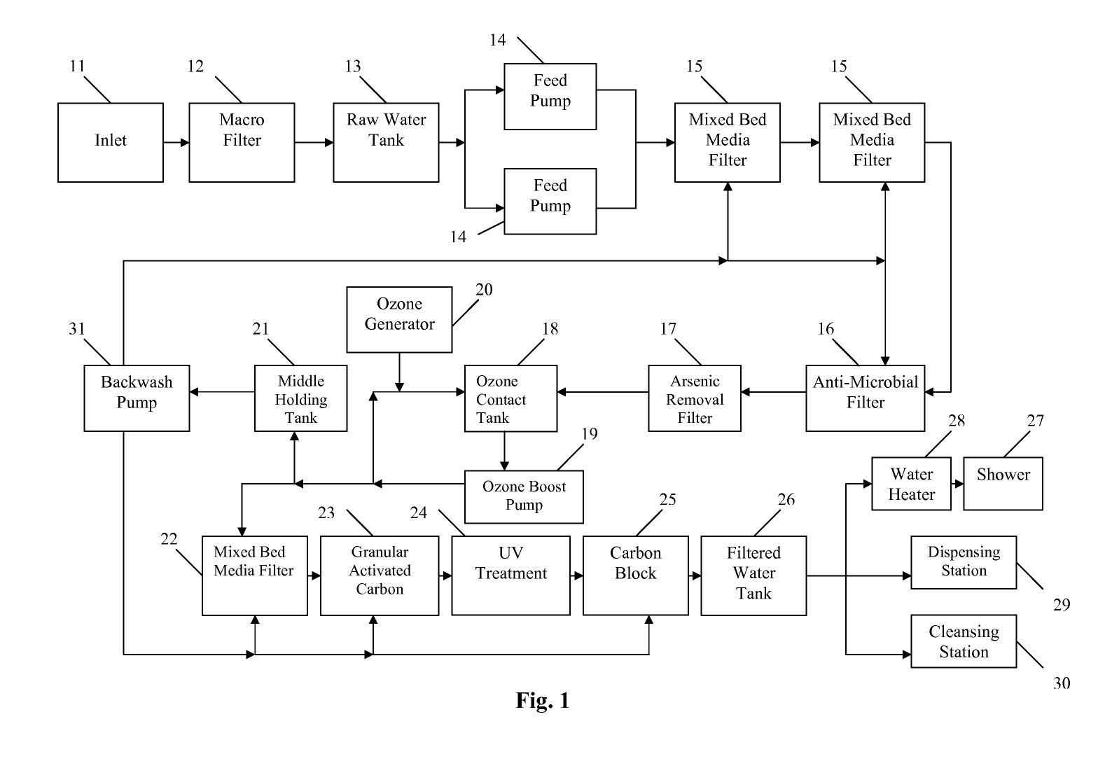

Referring now in detail to the drawings and, in particular, exemplary FIG. 1, a block diagram of the components of the system 10 according an embodiment of the present invention is shown. Contaminated water from a local source, such as a well, is piped in to system 10 through inlet 11 and then through macro filter 12 to filter out sediment and large particles. Preferably the macro filter 12 filters out particles greater than one-sixteenth of an inch. The water then travels through raw water tank 13, which preferably is constructed of either fiber reinforced polymer or 304 stainless steel and has a capacity of about 100 gallons, an inlet size of one inch, and an outlet size of one and a quarter inch. Other suitable materials and sizes may be used as well.

The water then splits into two paths and travels in parallel to feed pumps 14, which maintain the water in the system at 30-40 psi, which is an optimal pressure for the water purification system according to embodiments of the present invention. The feed pumps 14 each preferably may sustain a flow rate of at least 1.5 m³/h, have a head of about 37 m and a power of about 0.75 kW and are constructed of 304 stainless steel.

After feed pumps 14, the parallel water paths join, and the water then travels through two mixed bed multimedia filters 15 in series to mechanically filter out smaller particles, such as dirt, sediments, and algae. The mixed bed media filters 15 are preferably each 12×40 mesh multimedia in a housing constructed of either fiber reinforced polymer or fiberglass or 304 stainless steel. Alternatively, a single mixed bed filter could be used or two mixed bed media filters in parallel instead of in series. The media consists of a bottom layer of fine grain garnet media, a middle layer of silicate and an upper layer of course grain filter grade anthracite. The exact properties depend on the analysis of the source water. In addition, mixed bed media filters 15 preferably have a capacity of 50 gallons each, inlets and outlets of 1 inch each, a maximum pressure rating of at least 150 psi and a working pressure of about 30-50 psi. In addition, the inlet and outlet grates to mixed bed media filters 15 are preferably rated at 100 microns.

After the mixed-bed multimedia filters 15, the water passes through an specialized media filter 16 to actively destroy and remove microorganisms. The anti-biocontaminant material can be contained in a housing constructed of fiber reinforced polymer or 304 stainless steel that has a capacity of 50 gallons an inlet and outlet of 1 inch each, a maximum pressure rating of at least 150 psi, a working pressure of about 30-50 psi, and inlet and outlet grates rated at about 100 microns.

Next, the water passes through an optional arsenic removal filter 17. Preferably, the arsenic removal filter 17 is a 30×60 mesh arsenic removal media contained in a housing constructed of fiber reinforced polymer or 304 stainless steel has a capacity of 50 gallons an inlet and outlet of 1 inch each, a maximum pressure rating of at least 150 psi, a working pressure of about 30-50 psi, and inlet and outlet grates rated at about 100 microns.

The specialized media filter (or an additional specialized media filter) may also be placed near the end of the system, after the UV and before the carbon block. This configuration would save on the cost of the media, as replacement of the filter cartridge would be far less frequent.

Next, the water passes into the Ozone Contact Tank 18 where it undergoes ozonation. During the ozonation cycle, water is pumped out of the Ozone Contact Tank 18, which is preferably constructed from 316 stainless steel and has a capacity of 50 gallons, an inlet of 1 inch and an outlet of 1¼inch. The water is pumped by the Ozone Boost Pump 19, which preferably can sustain a flow rate of 2.5 m³/h and has a hoist of about 30 m and a power of about 0.6 kW and is made of 316 stainless steel. Next, the water is combined with the ozone, preferably at a dosage of about 2 mg/l, from the Ozone Generator 20, which preferably has at least a 2 g/h capacity, and fed back into the Ozone Contact Tank 18. This cycle preferably lasts for about four minutes. After the ozonation cycle is completed, ozonated water is pumped out of the Ozone Contact Tank 18. A portion of the ozonated water can be fed into a Middle Holding Tank 21, which is preferably constructed from 316 stainless steel and has a capacity of 50 gallons, an inlet of 1 inch and an outlet of 1¼inch, where it is stored for later use in a backwashing cycle.

The remainder of the ozonated water travels to a Post Depth Mixed-Bed Media Filter 22 to mechanically filter out any particles that may have grown in size due to oxidation. The Post Depth Mixed Bed Media Filter 22 is preferably a 12×40 mesh multimedia in a housing constructed of either fiber reinforced polymer or 304 stainless steel has a capacity of 50 gallons, inlets and outlets of 1 inch each, a maximum pressure rating of at least 150 psi, a working pressure of about 30-50 psi, and inlet and outlet grates rated at about 100 microns. The media types are the same as the pre-depth, although the proportions will be different and it will adsorb in different proportions.

Next, the water passes through Granular Activated Carbon (“GAC”) filter 23 to absorb organic and inorganic contaminants and to improve taste. The Granular Activated Carbon filter 23 is preferably a 12×40 granular activated carbon in a housing constructed of either fiber reinforced polymer or 304 stainless steel, and has a capacity of 50 gallons, inlets and outlets of 1 inch each, a maximum pressure rating of at least 150 psi, a working pressure of about 30-50 psi and inlet and outlet grates rated at 100 microns.

Following the GAC filter 23, the water passes through a UV Sterilization Unit 24 to destroy any remaining microorganisms. Preferably, UV Sterilization Unit 24 is constructed of 304 stainless steel, is designed for a flow rate of about 12 gallons per minute, uses UV at a wavelength of 254 nanometers, and consumes power at a rate of about 35-45 W. Other suitable wavelengths may be used as well.

Following UV treatment, the water passes through at least one Carbon Block 25 filter. Preferably, four carbon blocks are connected in parallel. Each carbon block is preferably a 4⅝×20 inch cartridge with a 0.5 micron rating, contained in a 23⅜×7¼ inch housing, constructed of polypropylene or 304 stainless steel with an inlet and outlet of 1 inch, a maximum pressure of about 90 psi, and a working pressure of about 10-20 psi.

Following filtration, water can be stored in a Filtered Water Tank 26. Tank 26 is preferably constructed of fiber reinforced polymer or 304 stainless steel and has a 100 gallon capacity, an inlet of 1 inch and an outlet of 1¼inch. Water stored in tank 26 is available for later use by a shower 27 via a tankless water heater 28, one or more dispensing stations 29, or a vessel cleansing station 30. As an alternative, ozonated water from the middle holding tank 21 can be pumped to the vessel cleansing station. As another alternative, collapsible water storage bladders, preferably dimensioned at approximately 10 feet×14 feet and capable of holding 3,000 gallons each, may be utilized during emergency deployment situations. The bladders may be connected to the main system via flexible hoses and may be filled by appropriately sized boost pumps. The bladders may have backwash valves to prevent contamination of the system.

At periodic intervals, or when demand for filtered water is minimized, ozonated water from the middle holding tank 21 can be utilized to perform a backwash on the mixed bed media filters 15 and 22, the specialized filter 16, the arsenic removal filter 17, the granulated activated carbon 23 and the carbon block 25. During such operation, water is pumped from the middle holding by the backwash pump 31, which can preferably can sustain a flow rate of at least 1.5 m³/h, has a hoist of about 37 m and a power of about 0.75 kW and is constructed of 304 stainless steel.

The water filtration system 10 can be powered by an external power source, or if none is available, is equipped with a fuel powered generator capable of a 5000 W output at 120/240 voltage.

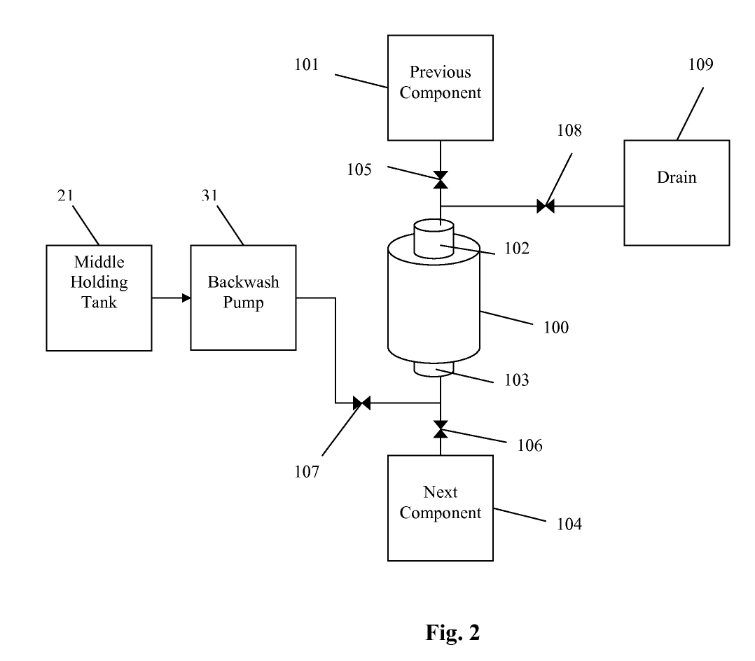

Referring now to FIG. 2, which depicts the backwashing capability of an embodiment of the system, filter 100 represents any of the mixed bed media filters 15 and 22, the specialized filter 16, the arsenic removal filter 17, the granulated activated carbon 23 and the carbon block 25. Ordinarily, during water purification, water is fed through the previous component, the filter inlet 102, and the filter 100, and out the filter outlet 103. The water is then fed into the next component 104 of the system. However, during backwashing operation, valves 105, 106 are closed and valves 107, 108 are opened. Water is then fed from the middle holding tank 21 by the backwash pump, in reverse, through filter 100. Ozonated water enters at the filter outlet 103, travels through the filter 100, out the filter inlet 102 and through to a drain 109. During this process, contaminants that have been trapped in filter 100 as a result of the filtration process are easily removed and disposed of, resulting in improved reliability and filtration capacity of the system. Automatic backwashing allows the system to extend the useful life of all cartridge filters in the system without substantial downtime. When the backwash cycle is complete, valves 107, 108 are closed, valves 105, 106 are opened, and the filtration process can resume.

The backwash with ozonated water can be performed in a sequence such as that outlined above, or individual filters can be backwashed individually on as as-needed basis dictated by pressure drop or poor quality water tested from sample valves.

An alternative configuration can be described which allows individual filters to be temporarily isolated, bypassed and backwashed without affecting normal purification operation of the system. This feature is made possible by the built-in redundancy of the system design.

FIG. 1 also shows a top down diagram of the components of the exemplary embodiment as they are installed in a mobile unit, including the raw water tank 13, feed pumps 14, mixed bed media filters 15, 22, specialized filter 16, arsenic removal filter 17, ozone contact tank 18, ozone boost pump 19, ozone generator 20, middle holding tank 21, backwash pump 31, GAC filter 23, UV sterilization unit 24, carbon blocks 25, filtered water tank 26, generator 32, instrumental air 33, control panel 34, and dispensing station 29. The back-up power source would be supplied with the unit, but operated outside the unit for safety and air quality reasons.

While only a small number of embodiments of the present invention has been shown and described, it is obvious that many changes and modifications may be made thereunto without departing from the spirit and scope of the invention.

It is also to be understood that the following claims are intended to cover all of the generic and specific features of the invention herein described and all statements of the scope of the invention which, as a matter of language, might be said to fall therebetween.

What is claimed is:

1. A system for treating contaminated water, comprising:
a water inlet;
a mesh screen filter connected to said water inlet;
a first mixed bed media filtration unit constructed and arranged to receive water from said mesh screen filter, said first mixed bed media filtration unit comprising a plurality of filter layers;
an anti-microbial filtration unit constructed and arranged to receive water from said first mixed bed media filtration unit, said anti-microbial filtration unit comprising a bacteriostatic and bacteriocidal substance;
an ozonation unit constructed and arranged to receive water from said anti-microbial filtration unit;
a second mixed bed media filtration unit constructed and arranged to receive water from said ozonation unit, said second mixed bed media filtration unit comprising a plurality of filter layers;
an activated carbon filter unit constructed and arranged downstream from said ozonation unit wherein said activated carbon filter unit comprises granular activated carbon; and
a UV sterilization unit constructed and arranged downstream from said ozone filtration unit.

2. The system of claim 1, wherein said activated carbon filter unit is constructed and arranged to receive water from said ozonation unit, and said UV sterilization unit is constructed and arranged to receive water from said activated carbon filter unit.

3. The system of claim 1, wherein said UV sterilization unit is constructed and arranged to receive water from said ozonation unit and said activated carbon filter unit is constructed and arranged to receive water from said UV sterilization unit.

4. The system of claim 1, wherein said mixed bed media filtration units each comprise a removable filter cartridge.

5. The system of claim 1, wherein said activated carbon filter unit comprises a removable filter cartridge.

6. The system of claim 5, further comprising an unfiltered water tank constructed and arranged to receive water from said mesh screen filter, wherein said first mixed bed media filter is constructed and arranged to receive water directly from said unfiltered water tank.

7. The system of claim 6, further comprising at least one feed pump constructed and arranged to receive water from said unfiltered water tank, wherein said first mixed bed media filter is constructed and arranged to receive water directly from said at least one feed pump.

8. The system of claim 1, further comprising a carbon block filter constructed and arranged downstream from said activated carbon filter unit.

9. The system of claim 8, wherein said carbon block filter is a removable 1 micron rated carbon block filter cartridge.

10. The system of claim 1, further comprising a middle holding tank constructed and arranged to receive water from said ozonation unit.

11. The system of claim 10, further comprising a backwash pump constructed and arranged to receive water from said middle holding tank and dispense water to each of said mixed bed media filtration units, said anti-microbial filtration unit, said activated carbon filter unit, and said carbon block filter

12. The system of claim 1, further comprising an arsenic filtration unit constructed and arranged to receive water from said antimicrobial filter, wherein said arsenic filtration unit comprises a removable filter cartridge, and wherein said ozonation unit is constructed and arranged to receive water directly from said arsenic filtration unit.

13. The system of claim 1, further comprising a filtered water tank constructed and arranged to receive filtered water.

14. The system of claim 13, further comprising at least one dispensing station constructed and arranged to receive water from said filtered water tank.

15. The system of claim 13, further comprising at least one cleansing station constructed and arranged to receive water from said filtered water tank.

16. The system of claim 13 further comprising a water heater constructed and arranged to receive water from said filtered water tank and at least one shower constructed and arranged to receive water from said water heater.

17. A system for purifying water, comprising:
a water inlet;
a mesh screen filter;
a first mixed bed media filtration unit comprising a plurality of filter layers;
an anti-microbial filtration unit comprising a bacteriostatic and bacteriocidal substance;
an ozonation unit;
a second mixed bed media filtration unit comprising a plurality of filter layers;
an activated carbon filter unit comprising granular activated carbon;
a UV sterilization unit; and
a backwash pump constructed and arranged to dispense water in reverse through each of said mixed bed media filtration units, said anti-microbial filtration unit, said activated carbon filter unit.

18. A method of purifying water comprising the steps of:
pumping water through a mesh screen filter;
pumping water from said mesh screen filter through a first mixed bed media filtration unit, wherein said first mixed bed media filtration unit comprises a plurality of filter layers;
pumping water from said first mixed bed media filtration unit through a anti-microbial filtration unit, said anti-microbial filtration unit comprising a bacteriostatic and bacteriocidal substance;
treating water from said anti-microbial filtration unit with ozone;
pumping said ozone treated water through an activated carbon filter unit; and
treating water from said activated carbon filter unit with UV radiation.

19. A method of purifying water comprising the steps of:
pumping water through a mesh screen filter;
pumping water from said mesh screen filter through a first mixed bed media filtration unit, wherein said first mixed bed media filtration unit comprises a plurality of filter layers;
pumping water from said first mixed bed media filtration unit through a anti-microbial filtration unit, said anti-microbial filtration unit comprising a bacteriostatic and bacteriocidal substance;
treating water from said anti-microbial filtration unit with ozone;
treating said ozone treated water with UV radiation; and
pumping said UV radiation treated water through an activated carbon filter unit.
